(19) United States
(12) Patent Application Publication
(10) Pub. No.: US 2009/0021336 A1
(43) Pub. Date: Jan. 22, 2009

(54) INDUCTOR FOR THE EXCITATION OF POLYHARMONIC ROTATING MAGNETIC FIELDS

(75) Inventors: Irving I. Dardik, Califon, NJ (US); Shaul L. Lesin, Meitar (IL); Herman D. Branover, New York, NY (US); Michael Khavkin, Beer-Sheva (IL); Arkady K. Kapusta, Beer-Sheva (IL); Boris M. Mikhailovich, Beer-Sheva (IL); Ephim G. Golbraikh, Beer-Sheva (IL)

Correspondence Address: GREENBERG TRAURIG, LLP, 1200 SEVENTEENTH STREET, SUITE 2400, DENVER, CO, 80202, US

(73) Assignee: Energetics Technologies, LLC, Califon, NJ (US)

(21) Appl. No.: 12/112,114

(22) Filed: Apr. 30, 2008

Related U.S. Application Data
(63) Continuation-in-part of application No. 11/712,697, filed on Feb. 28, 2007, now Pat. No. 7,449,143.
Application No. 11/712,697 is a division of application No. 10/738,910, filed on Dec. 16, 2003, now Pat. No. 7,350,559.
(60) Provisional application No. 60/986,057, filed on Nov. 7, 2007.
(60) Provisional application No. 60/517,359, filed on Nov. 4, 2003.
(60) Provisional application No. 60/434,230, filed on Dec. 16, 2002.

(51) Int. Cl. H01F 30/12; G05F 3/00

(52) U.S. Cl. 336/5; 323/205

(57) ABSTRACT

An inductor for the excitation of polyharmonic rotating magnetic fields (RMF) for controlling the crystalline structure of continuous ingots and castings in metallurgy and other foundry applications. The inductor design makes it possible to use standard sources of sinusoidal currents for generating polyharmonic RMF, and significantly increase cos φ of the inductor.

This application claims priority from Provisional U.S. Patent Application Ser. No. 60/986,057, filed Nov. 7, 2007, and is a Continuation-in-Part of and claims priority from U.S. patent application Ser. No. 11/712,697, filed on Feb. 28, 2007, which is a Divisional of U.S. patent application Ser. No. 10/738,910, filed on Dec. 16, 2003, and claims the benefit of U.S. Provisional Patent Application Nos. 60/517,359, filed Nov. 4, 2003, and 60/434,230, filed Dec. 16, 2002, each of which is hereby incorporated by reference in its entirety.

This application includes material which is subject to copyright protection. The copyright owner has no objection to the facsimile reproduction by anyone of the patent disclosure, as it appears in the Patent and Trademark Office files or records, but otherwise reserves all rights.

### FIELD

The instant disclosure relates to the field of inductors, and more particularly to inductors for exciting polyharmonic rotating magnetic fields.

### BACKGROUND

Certain RMF excited by multi-phase systems of currents harmonically varying in time are used in metallurgy and foundry processes, such as refining the structure of continuous steel ingots and castings, increasing mixing, and intensifying the melting process of metals and alloys in furnaces. A. B. Kapusta et al., Improved Test-Industrial Electromagnetic Equipment, Magnetohydrodynamics, v. 9, No. 2, 288-89 (1973). The design of inductors used for these purposes and their electromagnetic characteristics have been improved over time, and the effects in melts of using certain polyharmonic (in particular, amplitude- or frequency-modulated) RMF have been noted. K. H. Spitzer, G. Reiter, & K. Schwerdtfeger, Multi-frequency Electromagnetic Stirring of Liquid Metals, ISIJ International, v. 36, No. 5, 487-92 (1996); H. Branover et al., On the Potentialities of Intensification of Electromagnetic Stirring of Metals, Magnetohydrodynamics, v. 42, No. 2-3, 3-9 (2006).

However, the practice has shown that the excitation of polyharmonic RMF by means of available designs of inductors involves difficulties. Non-sinusoidal current sources, such as the 360-AMX AC Power Source “Pacific Smart Source”, make it hard to choose optimal modes of feeding coils and difficult to compensate reactive currents in the secondary circuit of the source, thereby consuming substantially more power than inductors constructed according to the present invention. Alternatively, when two or more sinusoidal current sources are used to feed coils of the known designs of inductors, there are problems protecting the sources from currents of other frequencies in secondary circuits.

### SUMMARY

The instant disclosure is directed to an inductor devoid of these drawbacks. In the present invention, the magnetic circuits related to different frequencies are isolated from each other, and the magnetic fields of different frequencies are excited by sinusoidal currents.

Additional features and advantages of the invention will be set forth in the description which follows, and in part will be apparent from this disclosure, or may be learned by practice of the invention. Some objectives and other advantages of the invention will be realized and attained by the structure particularly pointed out in this written description, including any claims contained herein and the appended drawings.

In some embodiments, RMFs are modulated, and not currents in the inductor windings. If comparatively low values of the relative frequency ω̅=μ₀σω₀R₀²≦4 are used, the magnetic fields of the currents induced in the melt are low, and induced currents of other frequencies in secondary circuits having sinusoidal sources are insignificant. The reactive currents at each of the frequencies of the applied spectrum are compensated for, drastically reducing the power consumed.

In some embodiments, an inductor for the excitation of polyharmonic rotating magnetic fields (RMF) is provided, the inductor comprising a magnetic core with 1 nm explicit poles (where m is the number of phases, n is the number of poles per phase, and 1 is the number of frequencies). The 1 nm explicit poles have 1 nm coils co-located with them. The 1 nm pole/coil assembly is placed in a case comprising a supporting plate, a heat-insulated screen, a jacket, and a system of natural or forced cooling, wherein said magnetic core comprising magnetically isolated parts, each of them ensuring the excitation of RMF of a certain frequency within the inductor bore.

In some embodiments the poles of the inductor are substantially the same size; in some embodiments the poles are different sizes.

In some embodiments, the backs of the magnetically isolated parts in the magnetic core are disposed symmetrically with respect to the horizontal plane of mirror symmetry of the inductor bore.

In some embodiments, the backs of the magnetically isolated parts in the magnetic core are disposed asymmetrically with respect to the horizontal plane of mirror symmetry of the inductor bore.

In some embodiments, the inductor comprises sectional coils, wherein the number of turns in each section ensures the maximal magnetomotive force value in the technologically conditioned frequency range.

It is to be understood that both the foregoing general description and the following detailed description are exemplary and explanatory and are intended to provide further explanation of the disclosed inductor for the excitation of polyharmonic rotating magnetic fields.

### BRIEF DESCRIPTION OF THE DRAWINGS

The accompanying drawings, which are included to provide a further understanding of the disclosed inductor for the excitation of polyharmonic rotating magnetic fields and are incorporated in and constitute a part of this specification, illustrate various embodiments and, together with the description, serve to explain the principles of at least one embodiment of the disclosed inductor for the excitation of polyharmonic rotating magnetic fields.

In the drawings:

FIG. 1 is a diagram illustrating a vertical cross-section taken along line B-B of an inductor in accordance with an embodiment.

FIG. 2 is a diagram illustrating a horizontal cross-section taken along line A-A of an inductor in accordance with an embodiment.

FIG. 3 is a diagram illustrating a vertical cross-section taken along line C-C of an inductor in accordance with an embodiment.

FIG. 4 is a diagram illustrating a horizontal cross-section taken along line C-C of an in-mold inductor having a square cross-section in accordance with an embodiment.

FIG. 5 is a diagram illustrating a vertical cross-section taken along line AOB of an inductor in accordance with an embodiment.

FIG. 6 is a diagram illustrating a horizontal cross-section taken along line C-C of an in-mold inductor having a circular cross-section in accordance with an embodiment.

FIG. 7 is a diagram illustrating a vertical cross-section taken along line A-A of an inductor in accordance with an embodiment.

### DETAILED DESCRIPTION

Reference will now be made in detail to embodiments of the disclosed inductor for the excitation of polyharmonic rotating magnetic fields, examples of which are illustrated in the accompanying drawings.

Metals foundries and the chemical industry are among the most energy-consuming industries in many developed countries. By way of example, without limitation, electric energy consumption in the production of alloyed steels in arc furnaces can amount to 400-500 kW-h/ton (it is to be understood that these numbers relate only to the steel production process and do not include electric energy consumption for cast iron production and steel rolling). The electric energy consumed for the production of one ton of magnesium alloys in electric resistance furnaces and for the production of one ton of copper alloys in channel induction furnaces can approach 400 kW-h. The intensive mixing of molten metal during casting is vital for the production of high-quality steel. As described below, the introduction of forces by means of the disclosed inductor intensifies mixing and, at the same time, also significantly decreases the electric energy consumption and considerably increases the economic efficiency.

The following calculation is presented solely for the purpose of demonstrating the potential savings associated with utilizing the disclosed inductor. The cost of electrical power can vary by location, time of day, and peak power consumed, but for the sake of this calculation will be assumed to be at least 15 cents/kW-h. Hence, the cost of the above mentioned 400-500 kW-h/ton is $60-75 per ton of metal. The total cost of production of steel sheet and profiled steel is approximately $300/ton. It follows then that the cost of electric energy consumed for steel production in furnaces—the share of the expenses which can be substantially reduced by using the disclosed inductor—is in the range of about 20-25% of the total metallurgical product cost.

The productivity of a metals foundry in producing and treating melts is determined by the rate of the processes of melting. Similarly, the productivity of a chemical plant is determined by reaction rates of various constituents of chemical solutions and the dissolution of added reagents. The rate of the above-mentioned processes, all other conditions being equal, depend upon the stirring intensity of the melt or chemical solution, respectively. Stirring intensity can also determine the structure of a crystal as it forms from a melt, and influence the final mechanical properties of an ingot or casting. The stirring intensity of melts and solutions can be a principal factor determining the efficiency of a metals foundry or chemical plant, as well as the quality of their end products.

Estimations of the mean velocity of a turbulent rotating MHD flow show that the velocity is proportional to the square root of the magnitude of the electromagnetic body force, which, in turn, is proportional to the slip, i.e., to the difference ω/p-Ω: where ω/p is the angular velocity of RMF rotation, p is the number of pole pairs, and Ω is the angular velocity of melt rotation. Thus, mean angular velocity of the rotation of the turbulent flow quasi-solid core is determined by the following simple expression from the E. Golbraikh, A. Kapusta, and B. Mikhailovich presentation “Semiempirical Model of Turbulent Rotating MHD Flows” at the Proc. 5th Internal. PAMIR Conf., Ramatuelle, France, Sep. 16-20, 2002, I-227-I-230 (which is also incorporated by reference herein in its entirety):

Ω≈(Q/2)[(1+4/Q)^{1/2}−1)]ω,

where Q=Ha²·δ_{Z}/Re_{ω}·C₀; where Ha=B₀R₀(σ/η)^{1/2}; δ₂=Z₀/R₀; Z₀ is the melt height; R₀ is the radius of the container with melt; Re_{ω}=ωR₀²/ν; ν is the kinematic viscosity of the melt; σ is the electrical conductivity of the melt; and, C₀=0.018 is an empirical constant.

The time required for a complete homogenization of the melt composition or temperature, during turbulent stirring is inversely proportional to the angular velocity of the fluid rotation. Hence, with an approximately 1.5-fold increase in the rotation velocity, the homogenization time is decreased by the same ratio. Since the homogenization time accounts for approximately 50% of the total casting time, a 1.5-fold increase in the rotation velocity can account for about a 20% reduction of melting duration in electric furnaces, and approximately 50% acceleration of desulfurization and dephosphorization reactions in MHD facilities for out-of-furnace treatment.

The power of stirring MHD facilities generally amounts to approximately 1-1.5% of furnace transformer power, therefore reducing the melting duration can leads to an extremely significant reduction in electrical energy consumption. A 1.5-fold decrease in melting duration in arc furnaces reduces the specific electric energy consumption down to about 270-330 kW h/ton, (i.e., the specific electric energy saving will amount to about 130-170 kW h/ton, and thus $20-26/ton).

As demonstrated by Pestel et al., U.S. Pat. No. 2,963,758, which is hereby incorporated by reference herein in its entirety, the optimal crystalline structure of a steel ingot may be obtained under the following condition:

ωB²R²≈5×10⁻³−11.3×10⁻³T²m²/s,

where ω is the angular velocity of the magnetic field rotation, in rad/s; B is magnetic induction, in T; and R is the liquid crater radius, in m. Hence, the necessary value of the magnetic induction is:

B˜0.04-0.06T

Inductors installed at continuous casting facilities (“CCF”) generate a magnetic field in the melt. The rotating (traveling) magnetic field induces currents, whose interaction with said field results in the appearance of electromagnetic forces affecting the melt. The nominal power of the inductors amounts to about 150-300 kW at a specific electric energy consumption, (i.e., about 10-12 kWh/ton), depending on the CCF type and productivity. When using amplitude and frequency modulated currents, at a comparable power of the inductors, the ingot crystallization process is considerably accelerated, which increases CCF productivity. Besides, strength characteristics of the cast metal are improved and its porosity decreases.

The inductor design according to various embodiments of the present invention allows the realization of the advantages of using multi-frequency (dual-frequency and higher) currents to excite an inductor while minimizing the feedback and losses seen in prior art inductors.

In some embodiments, RMFs are modulated, and not currents in the inductor windings. If comparatively low values of the relative frequency ω̅=μ₀σω₀R₀²≦4 are used, the magnetic fields of the currents induced in the melt are low, and induced currents of other frequencies in secondary circuits having sinusoidal sources are insignificant. The reactive currents at each of the frequencies of the applied spectrum are compensated for, drastically decreasing the power consumed.

In some embodiments, an inductor for the excitation of polyharmonic rotating magnetic fields (RMF) is provided, the inductor comprising a magnetic core with 1 nm explicit poles (where m is the number of phases, n is the number of poles per phase, and 1 is the number of frequencies). The 1 nm explicit poles have 1 nm coils co-located with them. The 1 nm pole/coil assembly is placed in a case comprising a supporting plate, a heat-insulated screen, a jacket, and a system of natural or forced cooling, wherein said magnetic core comprises magnetically isolated parts, each of them ensuring the excitation of RMF of a certain frequency within the inductor bore.

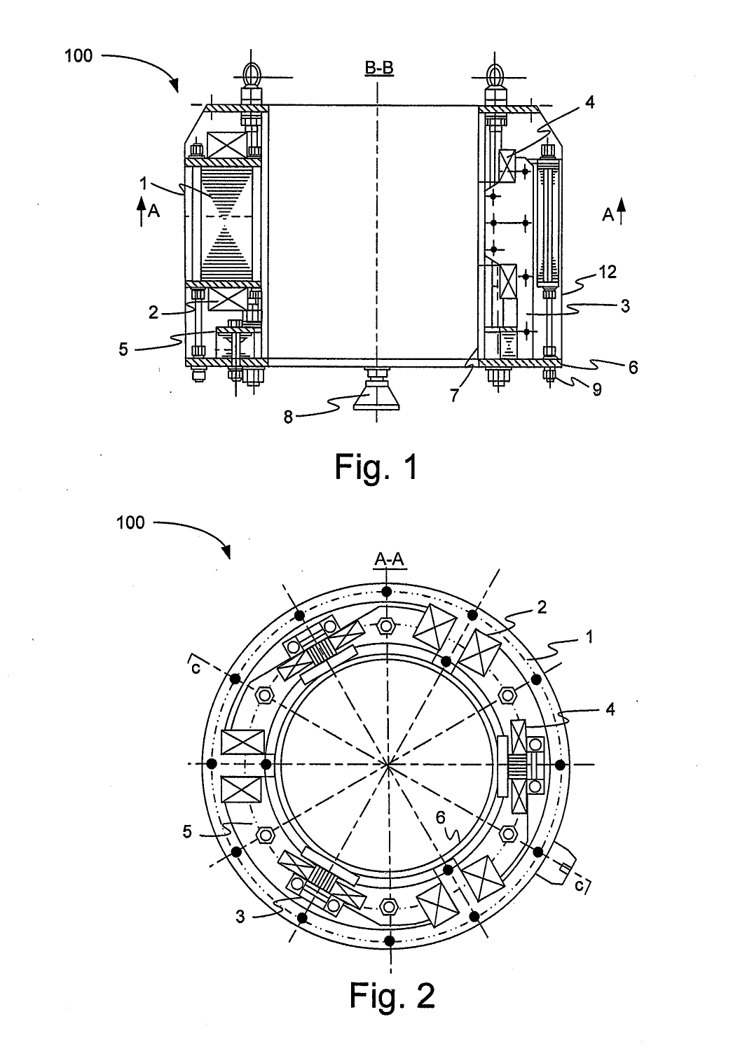

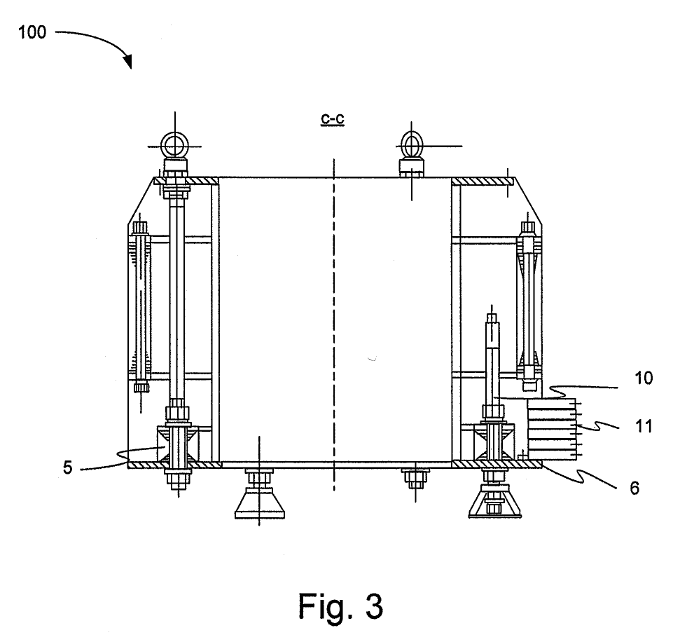

In some embodiments, as illustrated by FIGS. 1-3, a three-phase inductor with six explicit poles—l=2; n=1; m=3—for improving the quality of shaped castings is provided (referred to hereinafter as inductor 100). In some embodiments, poles can be formed from ferroceramics—a refractory material (e.g., chamotte, magnesite, chromomagnesite, or high-temperature concrete) with a powdered filler representing a ferromagnetic material, such as, but not limited to, iron, cobalt, or the like. The powder particle size may be 1 mm, for example, and the powder content in the refractory material may depend on the type of the refractory material used. After thorough stirring, such a material is produced in the form of individual elements with its shape depending on the design of a specific inductor, and then the material is baked. Up to the Curie temperature of the filler, the material retains its magnetic properties, is not electro-conducting, has a sufficiently low thermal conductivity, and can be used in the magnetic circuit of the inductor. Such a design of an RMF inductor makes it possible to arrange the RMF source maximally close to a melt, thereby reducing the inductor power required to achieve a certain level of stirring in the melt. Furthermore, such a design significantly reduces the magnitude of non-magnetic gap between the melt and the inductor and excludes magnetic field weakening by any intervening materials. Because the coils can be located in the high-temperature zone, their design also greatly differs from coils conventionally applied in metallurgical technology.

Referring back to the embodiments illustrated by FIGS. 1-3, inductor 100 comprises a magnetic core with back and poles 1 and coils 2 disposed thereon, thereby concentrating and strengthening the magnetic fields generated by coils 2 when excited by electrical current. Inductor 100 further comprises magnetic core with poles 3, coils 4, and back plate 5 arranged in a similar fashion. Magnetic core with poles 3 and coils 4 and magnetic core with poles 1 and coils 2 are assembled on non-ferromagnetic support plate 6 to magnetically isolate them from each other. In some embodiments, non-ferromagnetic support plate 6 may be made of non-ferromagnetic steel. In some embodiments, wherein the inductors are used in high-frequency applications, magnetic cores 1, 3 comprise laminated layers and may be tightened by studs 9. In some embodiments, ferromagnetic back plate 5, acting as a part of the magnetic core, may comprise one or more ferromagnetic materials, such as, but not limited to, Cobalt, Iron, Nickel, or the like.

In some embodiments, inductor 100 further comprises a thermally insulated shield 7, shield 7 having an external surface coated with a layer of thermal insulation, such as, but not limited to, glass fabric, or the like. Inductor 100 is further covered by jacket 12, and rests upon legs 8, 10. Connection to coils 2, 4 are provided by terminal block 11.

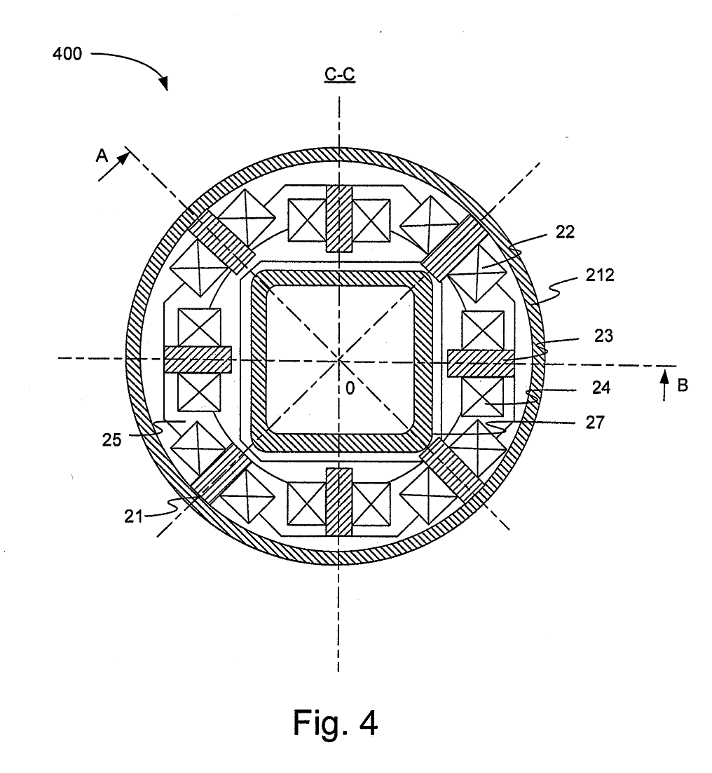

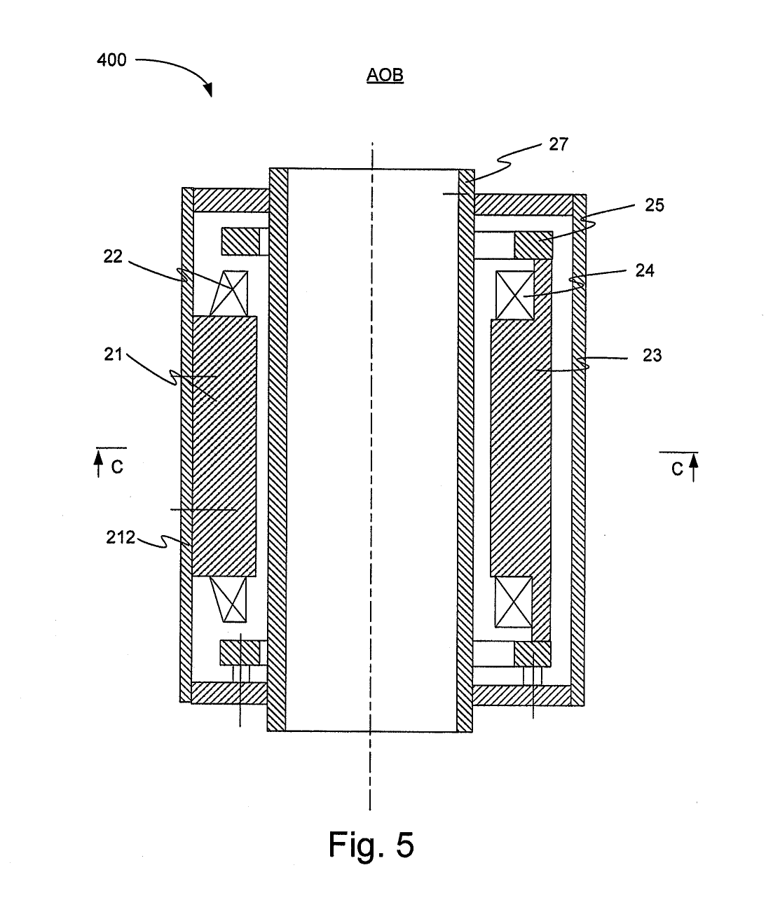

In some embodiments, as illustrated by FIGS. 4-5, a two-phase inductor with eight explicit poles—l=2; n=2; m=2—meant for improving the quality of a continuous ingot of square cross-section is provided (referred to hereinafter as inductor 400). Inductor 400 comprises back 212 and poles 21 with coils 22 disposed thereon, and a magnetic core comprising poles 23, back plates 25, and coils 24 disposed thereon. Back 212, poles 21, and coils 22 are magnetically isolated from the magnetic core and coils 24.

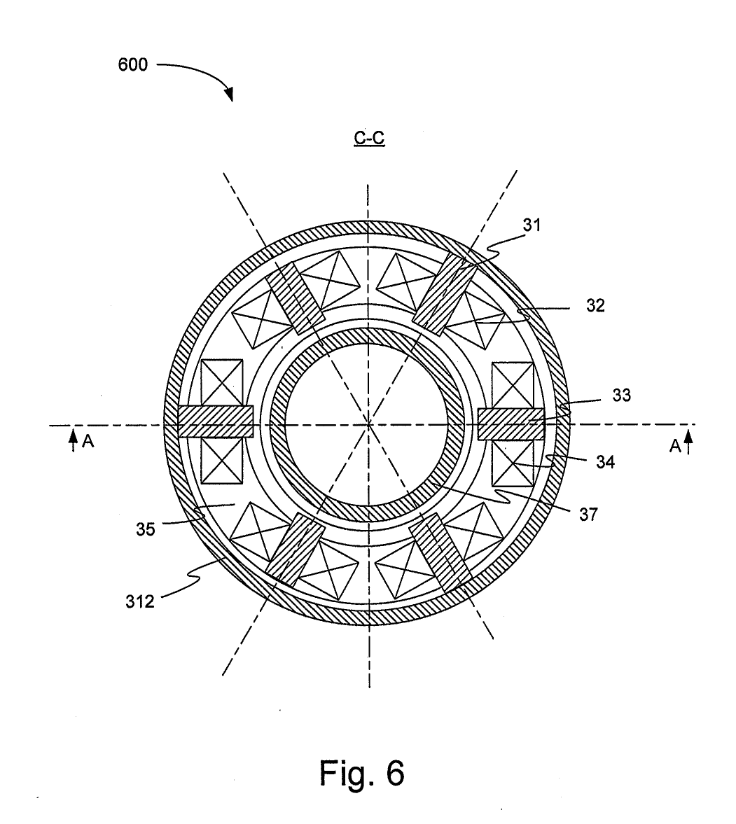

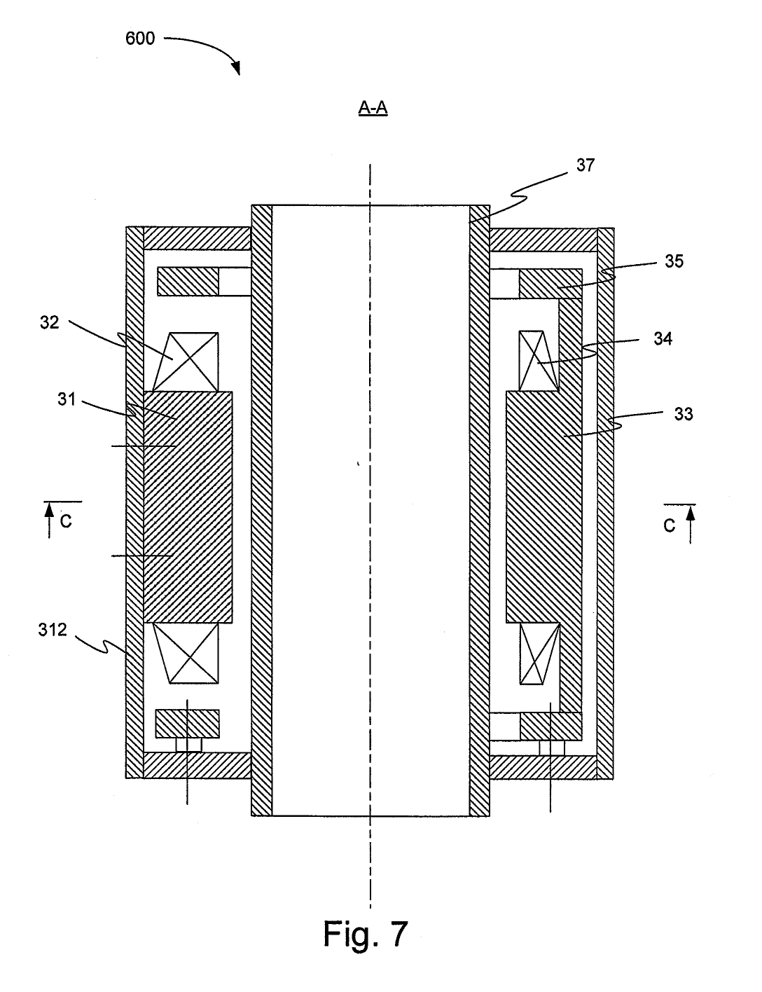

In some embodiments, as illustrated by FIGS. 6-7, a three-phase inductor with six explicit poles—l=2; n=1; m=3—meant for improving the quality of a continuous ingot of circular cross-section, is provided (referred to hereinafter as inductor 600). Inductor 600 comprises back 312 with poles 31 and coils 33 disposed thereon, and magnetic core 33 with back plates 35 and coils 34 disposed thereon. Back 312, poles 31, and coils 32 are magnetically isolated from magnetic core 33, 35 and coils 34.

In inductors used in continuous casting facilities, copper shield of the mold 27 (FIGS. 4-5), 37 (FIGS. 6-7) is used as a protective shield, and ferromagnetic supporting rings 25 (FIG. 5), 35 (FIG. 7) are used as back plates.

In some embodiments, inductors according to the present invention operated by connecting coils 2, 22, 32 to a sinusoidal current source of a certain frequency, and connection coils 4, 24, 34 to a sinusoidal current source of a different frequency, which excites a superposition of RMFs of two different frequencies in the working bore of the inductor. The resulting amplitude-modulated RMF excites a system of rotating amplitude-modulated currents in the melt, and their interaction generates azimuthal and radial electromagnetic body forces (EMBF) acting on the melt. Under the action of said EMBF having constant and varying with time components, a complicated turbulent dynamic structure arises in the melt, which intensifies the processes of heat and mass transfer in it, which determine the crystalline structure of ingots or castings.

If the sizes of poles related to different magnetic circuits are different, the modulation depth of the resulting RMF varies along the height of the inductor bore, which can be useful for obtaining an optimal structure over the casting height.

While detailed and specific embodiments of the inductor for the excitation of polyharmonic rotating magnetic fields have been described herein, it will be apparent to those skilled in the art that various changes and modifications can be made therein without departing from the spirit and scope of the inductor for the excitation of polyharmonic rotating magnetic fields. Thus, it is intended that the present disclosure cover these modifications and variations provided they come within the scope of any appended claims and/or their equivalents.

What is claimed is:

1. An inductor for the for the excitation of polyharmonic rotating magnetic fields comprising:
a support plate;
an electrical connector coupled to the support plate, the electrical connector capable of receiving an electrical current, the electrical current comprising at least one frequency, and at least one phase; and,
a plurality of poles coupled to the support plate, electrically coupled to the electrical connector and arranged around the inductor bore, the plurality of poles comprising at least two poles per frequency of the electrical current and at least one pole per phase of the electrical current, each pole further comprising a coil disposed thereon;
wherein the poles associated with each frequency are magnetically isolated from each other.

2. The inductor of claim 1, wherein at least one of the poles comprises at least one ferroceramic.

3. The inductor of claim 1, wherein the inductor further comprising an inductor bore, the inductor bore further comprising a shield.

4. The inductor of claim 3, wherein the shield is made of stainless steel.

5. The inductor of claim 1, the inductor further comprising an inductor bore, each pole of the plurality of poles being arranged at the same radial distance from the center inductor bore.

6. The inductor of claim 1, the inductor further comprising an inductor bore, at least one pole of the plurality of poles being arranged at radial distance from the center of the inductor bore that is different than the other poles within the plurality of poles.

7. The inductor of claim 1, the poles comprising a ferroceramic.

8. A method for minimizing reactive currents generated when applying polyharmonic currents to an inductor, the method comprising:
applying a first electrical current to a first plurality of poles, the first electrical current having a first frequency and at least two phases; and,
applying a second electrical current to a second plurality of poles, the second electrical current having a second frequency and at least two phases;
wherein the first plurality of poles and the second plurality of poles are magnetically isolated from each other.

9. The method of claim 8, further comprising:
applying a third electrical current to a third plurality of poles, the third electrical current having a third frequency and at least two phases;
wherein the third plurality of poles is magnetically isolated from the first plurality of poles and the second plurality of poles.
